(19) United States
(12) Patent Application Publication
(10) Pub. No.: US 2024/0220294 A1
(43) Pub. Date: Jul. 4, 2024

(54) VM Migration Using Memory Pointers

(71) Applicant: Microsoft Technology Licensing, LLC, Redmond, WA (US)

(72) Inventors: Bharat Srinivas PILLILLI, El Dorado Hills, CA (US); Bryan David KELLY, Carnation, WA (US)

(21) Appl. No.: 18/089,830

(22) Filed: Dec. 28, 2022

(51) Int. Cl. G06F 9/455

(52) U.S. Cl. CPC G06F 9/45558; G06F 2009/4557; G06F 2009/45583

(57) ABSTRACT

Techniques for migrating a virtual machine (VM) from being hosted by a first processing element to being hosted by a second processing element are disclosed. These processing elements have access to a common pool of data storage resources. VM data for the VM is stored at a first storage location in the common pool of data storage resources. As a part of the migration, the VM data is prevented from being moved. As a result, the VM data remains where it was originally stored despite the VM migrating to the second processing element. As another part of the migration, a memory pointer that points to the storage location of the VM data is accessed. The second processing element hosts a new VM, which is a migrated version of the initial VM, and accesses the storage location of the VM data via the memory pointer.

### BACKGROUND

A “system on a chip” (SOC) is a type of integrated circuit (IC). This IC can incorporate a central processing unit (CPU), input and output ports, analog inputs and outputs, and internal memory all on a single platform.

The term “socket” generally refers to a type of physical connection that enables a SOC to connect to a motherboard of a computer. Typically, the socket has a distinct mounting shape to ensure that the SOC is inserted correctly. A platform can include any number of sockets. A SOC mounted in a socket can be referred to as a “node” in the platform. A single platform can include 2 sockets, 3 sockets, 4 sockets, 8 sockets, or any number of sockets. Consequently, a single platform can also include various numbers of SOCs or nodes.

The term “coherency” refers to a technique for ensuring that all of the SOCs have the same view of a memory or a cache. Stated differently, “coherency” refers to the scenario where all of the processing elements are provided with the same view of shared data.

In a scenario where a single SOC is present (i.e. a “uniprocessor” system), only a single processing unit (aka processing element) is performing computations; consequently, only a single processing unit is reading or writing to a memory location. With this type of system, when a value in a storage location (e.g., memory or cache) is changed, all future read operations that are made by the processing unit and that are directed to the storage location will see the updated value.

In a scenario where multiple SOCs are present (i.e. a “multiprocessor” or “multicore” system), multiple processing elements can be operating at the same time using a shared storage location. It might be the case that each of the processing elements locally caches the data stored at a particular storage location. If a first processing element performs a write operation at the storage location (after a second processing element has already cached the data), then the second processing element might operate using an out-of-date cached version of the data. Such a scenario is often not desirable. A “memory coherence protocol” thus refers to a protocol that ensures the various processing elements operate in a coherent manner to avoid using stale data.

A “partitioned” platform refers to a platform in which logical partitions in the hardware are created. A partition can be formed between different SOCs in the sockets. For instance, a first SOC plugged into a first socket of the platform can be configured to run a first type of operating system while a second SOC plugged into a second socket of the platform can be configured to run a second type of operating system. A partition can also be formed in the memory resources. For instance, a set of one or more SOCs can be provided access to a first partition of memory while a second set of one or more SOCs can be provided access to a second partition of memory. The first set of SOCs may be prevented from accessing the second partition of memory, and the second set of SOCs may be prevented from accessing the first partition of memory. Accordingly, there are various different ways in which computing resources (e.g., SOCs, memory, etc.) can be configured.

A memory “interposer” is a unit that links multiple sockets together and that provides electrical interface routing for the SOCs in the sockets, particularly for accessing the memory resources. More specifically, the memory interposer enables the different SOCs in the sockets to access a pool of storage resources, which may include any type of persistable storage. The individual storage resources are typically not directly visible to the SOCs, but they are visible as a contiguous storage unit via the interposer. Thus, the interposer effectively abstracts the access to the storage resources for the SOCs in the sockets.

A “virtual machine” (VM) refers to a virtualized computing environment that behaves like a computer but that operates using virtual computing components, such as virtual CPUs, virtual memory, and so forth. Virtualization technology uses software (e.g., a hypervisor) to abstract a computer's hardware components to create additional virtual components. Thus, the computer's SOCs and memory can be abstracted and used in a virtual manner.

Building on the above understanding, a person skilled in the art will appreciate how any number of VMs can be instantiated on a multi-socket platform. A “VM migration” refers to the process or task of transferring or moving a VM from a first hardware environment to a second hardware environment. This transfer includes not only transferring the virtualized components of the VM but also the underlying data that the VM uses. As an example, suppose a multi-socket platform includes two SOCs. A first one of the SOCs may be hosting a VM. A VM migration can occur where the VM is migrated from using the hardware of the first SOC to subsequently using the hardware of the second SOC in the multi-socket platform.

VM migrations can happen for any number of reasons. Some reasons include, but certainly are not limited to, reasons related to node (e.g., SOC) maintenance, a VM requesting additional compute resources, and so on. During a VM migration, a significant amount of time can be spent on moving or copying data for the VM from one storage location to another storage location. In fact, the data transfer of a VM migration event can be one of the most computationally expensive operations. The data transfer consumes a large amount of time, bandwidth, and compute, and it is latency intensive while potentially adding more traffic to a potentially already congested network.

With traditional VM migration techniques, the data transfer occurs even when the VM migration involves one SOC/node on a multi-socket platform migrating to a different node on that same multi-socket platform. For instance, the VM may have data stored on a first SSD. With traditional VM migration techniques, the data stored on that first SSD might be migrated to a second SSD or perhaps to a new location on the first SSD. What is needed, therefore, is an improved technique for performing VM migration, particularly for nodes that exist on the same multi-socket platform.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments disclosed herein relate to systems, devices, and methods for migrating a virtual machine (VM) from being hosted by a first processing element to being hosted by a second processing element.

Some embodiments determine that the VM is to be migrated from being hosted by the first processing element to being hosted by the second processing element. The first processing element and the second processing element have access to a common pool of data storage resources. VM data for the VM is stored at a first storage location in the common pool of data storage resources. Optionally, some embodiments configure an interposer to be logically disposed between (i) the first processing element and the second processing element and (ii) the common pool of data storage resources.

The embodiments trigger a migration of the VM from initially being hosted by the first processing element to subsequently being hosted by the second processing element. As a part of the migration of the VM, the embodiments prevent the VM data from being transferred from the first storage location to a second storage location. As a result, the VM data is caused to remain at the first storage location despite the migration of the VM to the second processing element.

As another part of the migration of the VM, the embodiments generate or access a memory pointer that points to the first storage location in the common pool of data storage resources. The embodiments also cause the second processing element to host a new VM, where the new VM is a migrated version of the VM.

The embodiments then configure the new VM to access the first storage location via the memory pointer. The new VM uses the memory pointer to access the VM data, which continuously remained stored at the first storage location during the migration of the VM.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example architecture comprising a multi-socket platform and multiple nodes.

FIG. 2 illustrates multiple processing elements that can access a common pool of storage resources.

FIG. 3 illustrates an example technique for migrating a VM.

FIG. 4 illustrates a flowchart of an example method for improving the migration of a VM.

FIG. 5 illustrates an example computer system that can be configured to perform any of the disclosed operations.

### DETAILED DESCRIPTION

Embodiments disclosed herein relate to systems, devices, and methods for migrating a virtual machine (VM) from being hosted by a first processing element to being hosted by a second processing element. The migration is performed using less bandwidth and less computing resources, thereby decreasing the amount of latency involved with performing the migration.

A VM is to be migrated from the first processing element to the second processing element. These processing elements have access to a common pool of data storage resources. VM data for the VM is stored at a first storage location in the common pool of data storage resources. As a part of the migration, the embodiments prevent the VM data from being moved. As a result, the VM data remains where it was originally stored despite the VM migrating to the second processing element. As another part of the migration, the embodiments generate or access a memory pointer that points to the storage location of the VM data. The second processing element hosts a new VM, which is a migrated version of the initial VM. The new VM is configured to access the storage location of the VM data via the memory pointer.

### Examples of Technical Benefits, Improvements, and Practical Applications

The following section outlines some example improvements and practical applications provided by the disclosed embodiments. It will be appreciated, however, that these are just examples only and that the embodiments are not limited to only these improvements.

The disclosed embodiments bring about significant benefits, advantages, and practical effects to the technical field of VM migration. With traditional VM migration techniques, the data associated with a VM was required to be moved to a new storage location during VM migration. The reading and writing of this data resulted in significant expenditures of computing resources, bandwidth, and time.

The disclosed embodiments, on the other hand, beneficially remove or eliminate the step of moving data. That is, by following the disclosed principles, the embodiments are able to migrate a VM from one processing element to another processing element while allowing the stored data for that VM to continue to reside at its original storage location. Instead of cutting and pasting (or reading and writing) the data to a new storage location, the embodiments generate or access pointers to the VM data and then configure the new VM to use those pointers to access the stored VM data. Consequently, the virtual components of a VM can be migrated while the saved underlying data can continue to remain at its original location. The embodiments thus forgo the previous need of having to transfer data. By following the disclosed principles, VM migration can now occur much faster than was previously done, even orders of magnitude faster.

The embodiments also improve the efficiency of the computer itself. By avoiding having to perform certain acts, the embodiments free up resources that otherwise would have been consumed. Consequently, the computer's resources can now be used to perform other operations. Accordingly, significant improvements in speed, efficiency, bandwidth usage, and latency are now achieved by the disclosed embodiments. These and numerous other benefits will now be discussed in more detail throughout the remaining portions of this disclosure.

### Example Architecture

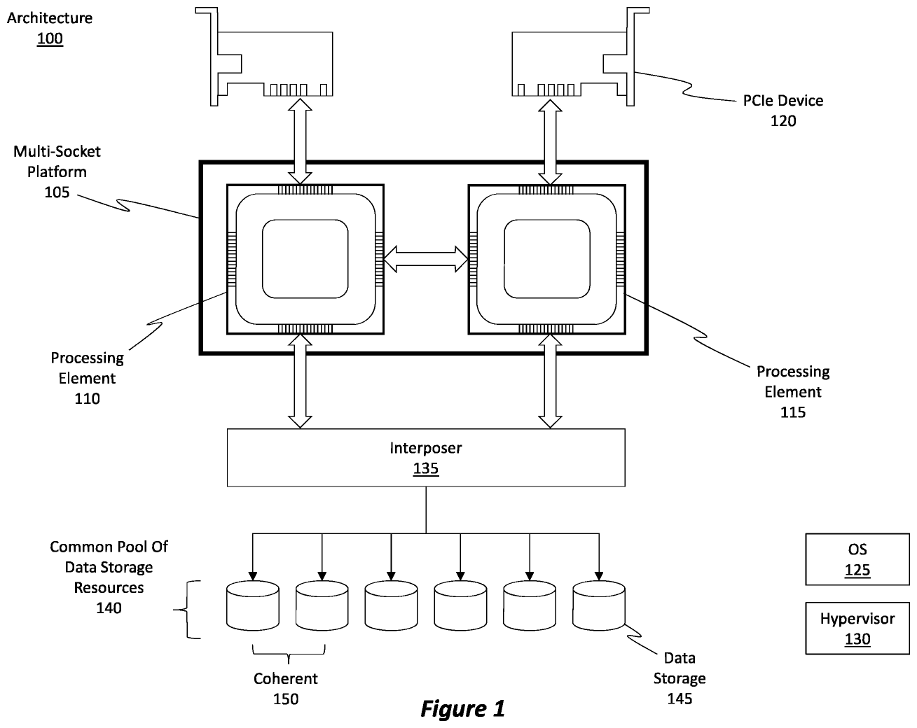

Attention will now be directed to FIG. 1, which illustrates an example architecture 100 that can be used to achieve the disclosed benefits. Architecture 100 is shown as including a multi-socket platform 105. A computer system can be designed to include any number of processing elements, such as central processing units (CPUs), systems on chip (SOCs), graphics processing units (GPUs), and so on. The multi-socket platform 105 is a hardware construct that enables those processing elements to be plugged into the computer system and to be provided access to the computer system's motherboard. FIG. 1 shows an example of a two socket platform, but a skilled person will recognize how a platform can be configured to include any number of sockets.

In FIG. 1, a first processing element 110 is plugged into a first socket of the multi-socket platform 105. Similarly, a second processing element 115 is plugged into a second socket of the multi-socket platform 105. These processing elements 110 and 115 can be any type of processing elements. For instance, the first processing element 110 can be a first SOC, and the second processing element 115 can be a second SOC. The first processing element 110 can be a first CPU, and the second processing element 115 can be a second CPU. The processing elements can even be or can include GPUs.

The first SOC, or rather the first processing element 110, can be referred to as a first “node” in the multi-socket platform 105. Similarly, the second SOC can be referred to as a second “node” in the multi-socket platform 105. Optionally, the multi-socket platform 105 can be configured to enable the processing elements 110 and 115 to directly communicate with one another. In some implementations, a connectable device can be provided to utilize the processing elements. For instance, in one example scenario, a PCIe device 120 can utilize the processing elements, as shown in FIG. 1.

In some implementations, the processing elements 110 and 115 operate under control of a single operating system (OS) 125. In another example scenario, the processing element 110 operates using a first OS, and the processing element 115 operates using a second OS. Such a scenario can particularly occur when the multi-socket platform is configured as a partitioned platform. For instance, the processing element 110 can be a first node in the multi-socket platform 105, the processing element 115 can be a second node in the multi-socket platform 105, and the multi-socket platform 105 can optionally be a partitioned platform. With a partitioned platform, the various computing elements can optionally be logically partitioned and isolated from one another. Further details on this aspect will be provided later.

In some cases, the processing elements 110 and 115 can operate under control of a single hypervisor 130. Although not shown, the processing elements 110 and 115 can be configured to host any number of VMs, and the hypervisor 130 can facilitate the virtualization or abstraction of the hardware components to support the VMs.

Architecture 100 is also shown as including an interposer 135, such as perhaps an NVMe interposer. The interposer 135 is a computing element that enables the processing elements to access a common pool of data storage resources 140, which include various data storage elements, such as data storage 145. The data storage 145 can be any type of data storage, including, but not limited to, solid state drives (SSD), hard disk drives, or any other type of persistable storage device.

Furthermore, in some implementations, the data storage can be configured to be coherent 150. In a multi-socket platform, the SOCs can (as indicated above) optionally share a common pool of memory resources. Furthermore, those SOCs can also be configured to act as a coherent domain. For instance, even though the platform includes multiple SOCs, or processing elements, those multiple SOCs can operate under the control of a single operating system (OS) or even a single hypervisor. Thus, even though there are multiple SOCs, those SOCs can be configured in a manner so that they appear as if they are a single processing element, and those SOCs can operate in a coherent manner. From this, a person skilled in the art will recognize how socket platforms provide a highly scalable system that can provide very customized levels of compute.

Using the interposer 135, the storage devices and resources can be made to appear to be contiguous to the processing elements 110 and 115. That is, despite there being multiple discrete data storage devices, these devices can appear as one (i.e. as “contiguous”) via use of the interposer 135. The interposer 135 thus provides a level of abstraction for the processing elements 110 and 115 so those elements do not need to consider the logistics as to how to store data.

Accordingly, in one example scenario, the common pool of data storage resources 140 includes a plurality of SSDs. The interposer 135 is logically disposed between (i) the processing element 110 and the processing element 115 and (ii) the plurality of SSDs. The interposer 135 causes the SSDs to appear to be contiguous to the processing elements 110 and 115.

In some example implementations, the storage resources can be configured to be coherent relative to one another. For instance, supposing the processing element 110 is a first node in the multi-socket platform 105 and the processing element 115 is a second node in the multi-socket platform 105, the multi-socket platform 105 can be configured to be a coherent platform in which the common pool of data storage resources 140 operate in a coherent manner.

### VM Data

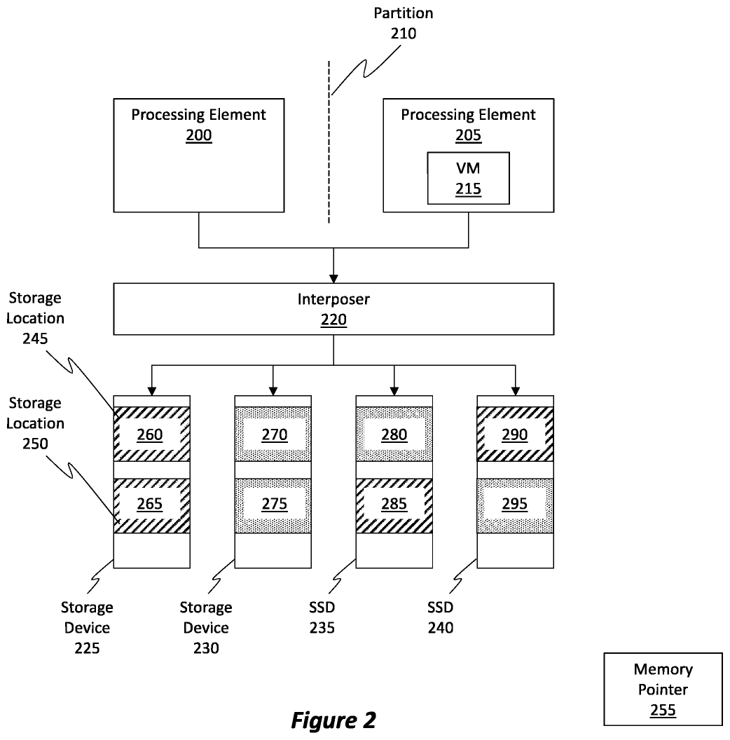

FIG. 2 shows further details regarding architecture 100 of FIG. 1. In particular, FIG. 2 shows processing elements 200 and 205, which are representative of processing elements 110 and 115 from FIG. 1, respectively. In some cases, the architecture can be a partitioned architecture, as shown by partition 210. In such a scenario, there is a logical divide or partition between some of the resources in the architecture.

FIG. 2 shows an example scenario where one node (e.g., the processing element 205) is hosting a VM 215. Although not shown, a hypervisor can be used to facilitate the processes of the VM 215.

FIG. 2 also shows an interposer 220, which is representative of the interposer 135 from FIG. 1. The interposer 220 is logically disposed between the processing elements 200 and 205 and various storage devices, such as storage device 225, storage device 230, SSD 235, and SSD 240. The storage devices 225 and 230 can be any type of storage device, without limit.

Storage device 225 is shown as having a number of different storage locations, such as storage location 245 and storage location 250. The storage locations 245 and 250 refer to memory blocks that are available for use on the storage device 225.

The hashing and dot patterns for the different storage locations in FIG. 2 correspond to storage locations that are being used by the processing elements 200 and 205. For instance, the hashing pattern corresponds to a storage location that is being used by processing element 205. Similarly, the dot pattern corresponds to a storage location that is being used by processing element 200. Further details on this aspect will be provided shortly.

Certain data is currently shown as being stored in the different storage locations. For instance, data 260 is shown as being stored at storage location 245 in the storage device 225. Similarly, data 265 is shown as being stored at storage location 250 in storage device 225. Data 270 and 275 is stored in storage device 230. Data 280 and 285 is stored in SSD 235. To complete the example, data 290 and 295 is stored in SSD 240.

Data 260, 265, 285, and 290 all reflect data that corresponds to the processing element 205. Similarly, data 270, 275, 280, and 295 all reflect data that corresponds to the processing element 200. For instance, data 260, 265, 285, and 290 may be data that is associated with the VM 215, which is being hosted by the processing element 205.

In some example implementations, VM 215 is initialized or allocated with a specified chunk or set of blocks of memory. The VM 215 can optionally be provided with a memory pointer 255 that points to the allocated memory for VM 215. For instance, the storage locations that are storing data 260, 265, 285, and 290 may have been allocated to the VM 215 when VM 215 was first initialized.

During traditional VM migration operations, the data that was associated with a VM would be transferred from one storage location to another storage location. For instance, using FIG. 2 as an example of the conventional approach, if VM 215 were migrated from being hosted by processing element 205 to being hosted by processing element 200, then the data 260, 265, 285, and 290 previously would have had to have been transferred over to a new location that was allocated or reserved for the processing element 200, or rather, for the newly migrated VM hosted by processing element 200. This data transfer process consumed significant amounts of bandwidth, time, and resources. The disclosed embodiments are able to avoid performing this data transfer, thereby providing significant improvements to the VM migration process.

### VM Migration

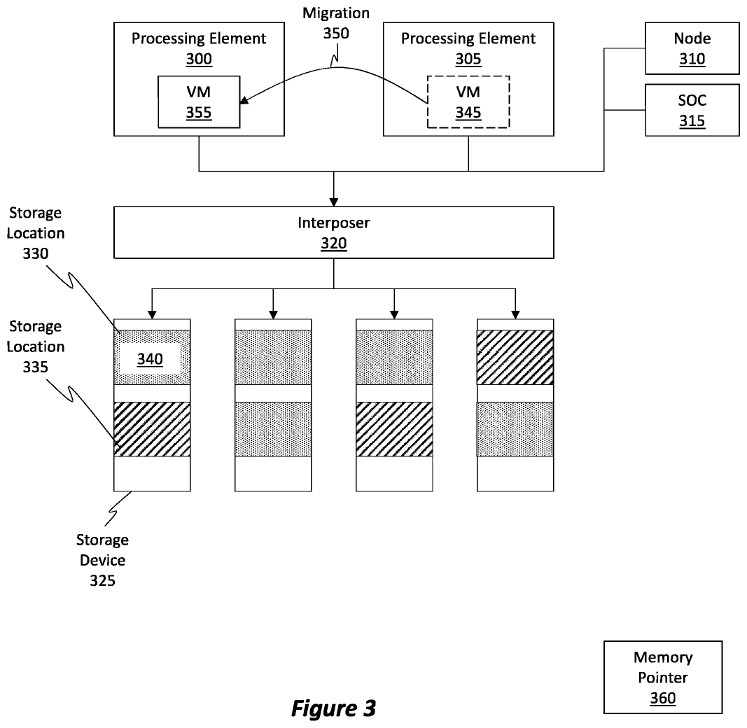

FIG. 3 describes a VM migration process performed in accordance with the disclosed principles. FIG. 3 shows many of the same computing elements as was described in FIGS. 1 and 2. In particular, FIG. 3 shows a processing element 300 and a processing element 305. These processing elements can be referred to as “nodes.” In some cases, the multi-socket platform can include more than two nodes. For instance, FIG. 3 shows an additional node 310 as well as a SOC 315, which can also be referred to as a node and which can be an example of a processing element.

FIG. 3 also shows an interposer 320, a storage device 325, a storage location 330 in the storage device 325, another storage location 335 in the storage device 325, and VM data 340 stored at the storage location 330. Processing element 305 is shown as hosting a VM 345, which is to be migrated from being hosted by the processing element 305 to being hosted by processing element 300, as shown by migration 350. The newly initialized VM 355 will be initialized as a part of the migration process; indeed, VM 355 is a migrated version of the VM 345. FIG. 3 also shows a memory pointer 360.

The VM 345, upon initialization, is allocated memory. Optionally, the memory pointer 360 can also be initialized at this point in time, and the memory pointer 360 can point to the VM 345's allocated memory. The VM 345 is then provided, as a part of the initialization, the memory pointer 360. In other scenarios, the memory pointer 360 is generated at a time subsequent to when the VM 345 is initialized, such as during the VM migration process.

In any event, the VM data 340 is associated with VM 345. As described herein, VM 345 is designated for migration from being hosted by the processing element 305 to being hosted by the processing element 300, as shown by migration 350. In accordance with the disclosed principles, the processes involved with VM migration are performed except that instead of transferring VM 345's data (e.g., VM data 340) from one storage location to another storage location, that VM data 340 is permitted to continue to reside at its original storage location. For instance, consider the difference between data 260 in FIG. 2 and data 340 in FIG. 3. Data 260 and data 340 correspond to the same underlying data.

Data 260 is shown as having the hashing pattern, which means that it was originally associated with VM 215, which is representative of VM 345 and which was hosted by processing element 205, which is representative of the processing element 305 from FIG. 3. In contrast, data 340 is now shown as having a dot pattern, which means it is associated with processing element 300, which is representative of the processing element 200 from FIG. 2. VM 355 is now allocated the storage location 330 via the memory pointer 360. Notably, the storage location 330 of the data 340 remains the same as the storage location 245 from FIG. 2, despite VM 345 migrating from processing element 305 to processing element 300, as shown by VM 355.

As a part of the migration process, the newly initialized VM 355 is provided the memory pointer 360, which points to the storage location 330 for the VM data 340. Thus, instead of transferring the VM data 340 from the storage location 330 to a different storage location, the embodiments provide the memory pointer 360 to the newly migrated VM 355 and instruct the VM 355 to use the VM data 340 stored at storage location 330.

The memory pointer 360 can be any type of pointer. In some implementations, the memory pointer 360 is a directory pointer (i.e. a pointer that points to a directory). In some implementations, the memory pointer 360 is a file system pointer (i.e. a pointer that points to a file system). The memory pointer 360 can point to one or more chunks or blocks of data.

Optionally, the memory pointer 360 can be an existing memory pointer that the VM 345 used to access the common pool of data storage resources while the VM 345 was being hosted by the processing element 305. For instance, the memory pointer 360 may have been created when the VM 345 was initialized. In some cases, the memory pointer 360 may have been created as a part of the migration process. Thus, if the memory pointer 360 was created prior in time to the VM migration, the embodiments are able to access the existing memory pointer 360. On the other hand, if the memory pointer 360 was created during the VM migration, then the embodiments are able to generate the memory pointer 360 as a part of the migration. In any event, the embodiments are able to avoid performing a data transfer operation, which, as discussed previously, is highly costly in terms of compute, bandwidth, and latency. Instead, the embodiments permit the data to reside at its original location. The embodiments then enable, via use of the memory pointer 360, a new VM to use the data storage locations that were previously allocated to a different VM.

### Example Method

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

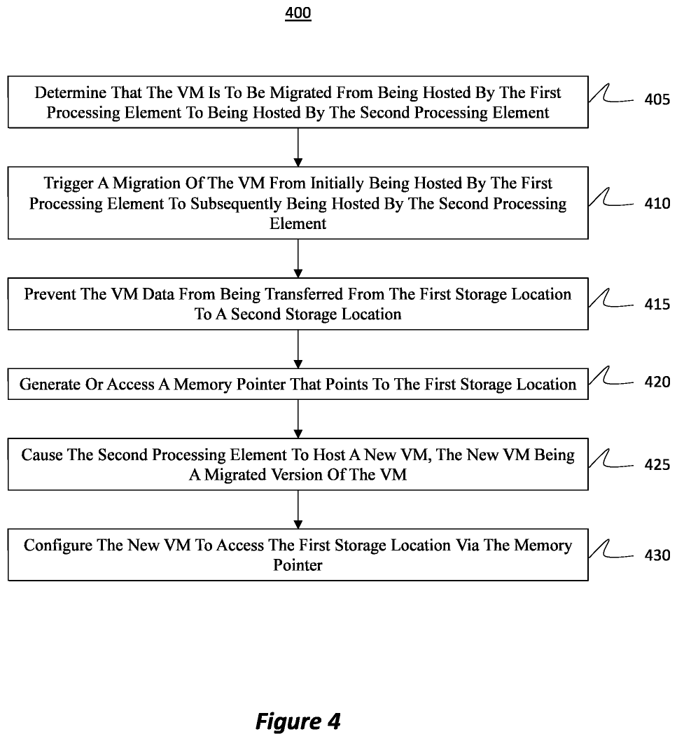

Attention will now be directed to FIG. 4, which illustrates a flowchart of an example method 400 for migrating a virtual machine (VM) from being hosted by a first processing element to being hosted by a second processing element. Method 400 can be implemented within the architecture 100 of FIG. 1 as well as those architectures presented in FIGS. 2 and 3.

Act 405 of method 400 includes determining that the VM is to be migrated from being hosted by the first processing element to being hosted by the second processing element. This determination can occur for any number of reasons, such as perhaps compute limitations associated with the VM, bandwidth limitations, storage limitations, maintenance reasons, and so on. The first processing element and the second processing element have access to a common pool of data storage resources, such as perhaps any number of SSDs or other types of persistable storage. Furthermore, VM data for the VM is stored at a first storage location in the common pool of data storage resources. It may be the case that the VM has data stored across multiple different storage devices. It may also be the case that the VM has data stored at multiple different locations on a single storage device.

Act 410 includes triggering a migration of the VM from initially being hosted by the first processing element to subsequently being hosted by the second processing element. As indicated above, this triggering can occur for any number of reasons.

As a part of the migration of the VM, act 415 includes preventing the VM data from being transferred from the first storage location to a second storage location. Consequently, the VM data is caused to remain at the first storage location despite the migration of the VM to the second processing element. If the VM has data stored at multiple different locations, including perhaps multiple different storage devices, then that data is also prevented from being transferred.

The process of preventing the VM data from being transferred from the first storage location to the second storage location involves refraining from performing a data cut and paste operation and/or a data copy and paste operation. Stated differently, preventing the VM data from being transferred includes refraining from reading the VM data for the purpose of then writing the VM data to a new location. Thus, both a read and a write operation are avoided.

As a part of the migration of the VM, act 420 includes generating or perhaps accessing a memory pointer. This memory pointer points to the first storage location in the common pool of data storage resources. If the VM had data stored at multiple different locations, then multiple memory pointers can optionally be created. In some cases, a single pointer can be configured to point to multiple different storage locations. In some cases, the embodiments generate a list comprising all the storage location where the VM has data stored. The embodiments can optionally generate a pointer that points to this list. Thus, in some cases, the memory pointer points directly to specific memory locations while in other cases the memory pointer points to a list that details or lists the locations where the VM stored data.

Act 425 includes causing the second processing element to host a new VM. Notably, the new VM is a migrated version of the VM. Optionally, the new VM can be configured to include different characteristics as compared to the original VM. For instance, the new VM might be configured to have increased compute capabilities or increased storage capabilities. If the new VM has increased storage capabilities, then that storage at least includes all of the storage of the previous VM, as mapped or as determined via the memory pointer(s), as well as potentially additional allocated memory. In one embodiment, the new VM is configured to have the same characteristics as the original VM.

Act 430 includes configuring the new VM to access the first storage location via the memory pointer. The new VM uses the memory pointer to access the VM data, which continuously remained stored at the first storage location during the migration of the VM. If VM data is distributed or located at other locations, the new VM can also use either the same memory pointer or other memory pointers to access that data as well. If the memory pointer points to a listing of storage locations where VM data is located, then the new VM can use the memory pointer to access that listing to then access the VM data.

In some cases, the original VM, upon initialization at the first processing element, is allocated virtual memory. This virtual memory can include virtual memory corresponding to the first storage location. Optionally, the new VM can be allocated the same virtual memory that was allocated to the original VM. In some cases, the new VM might be allocated additional virtual memory beyond that which was allocated to the original VM. In some embodiments, the new VM is allocated at least as much memory as was allocated the original VM. In some embodiments, the original VM might have been allocated an amount of memory, but the original VM consumed only a percentage of that memory. If allocated memory was not consumed, the memory pointer can be generated so as to point only to storage locations where actual VM data is located. The new VM can optionally be allocated less memory than the original VM, but the new VM is still provided with pointers pointing to all of the original VM's data.

In some implementations, the memory pointer points to all of the allocated memory that was allocated to the original VM, even if the memory is not storing VM data (i.e. is empty). Alternatively, the memory pointer might point only to storage locations that actually store VM data. Thus, there are different techniques for generating the memory pointer.

In some cases, the VM data may have been previously encrypted. If that is the case, then the encryption of the VM data remains unchanged during the migration of the VM. Stated more broadly, the features, characteristics, and attributes of the VM data remain unchanged during the migration process. The state that the VM data had prior to migration is the same state that the VM data has after migration. Accordingly, the VM data remains unchanged or unmodified during the migration of the VM.

By performing the disclosed operations, the embodiments are able to significantly speed up the VM migration process. Furthermore, the embodiments are able to improve the operational efficiency of the computer system, reduce bandwidth consumption, and decrease latency involved with migrating VMs.

### Example Computer/Computer Systems

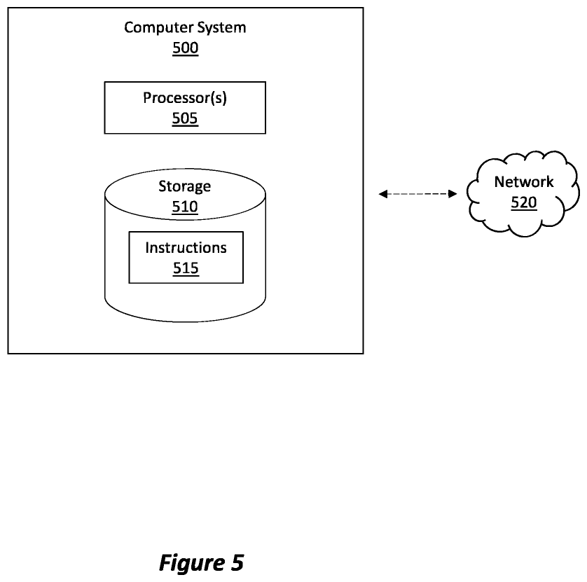

Attention will now be directed to FIG. 5 which illustrates an example computer system 500 that may include and/or be used to perform any of the operations described herein. Computer system 500 may take various different forms. For example, computer system 500 may be embodied as a tablet, a desktop, a laptop, a mobile device, or a standalone device, such as those described throughout this disclosure. Computer system 500 may also be a distributed system that includes one or more connected computing components/devices that are in communication with computer system 500.

In its most basic configuration, computer system 500 includes various different components. FIG. 5 shows that computer system 500 includes one or more processor(s) 505 (aka a “hardware processing unit”) and storage 510.

Regarding the processor(s) 505, it will be appreciated that the functionality described herein can be performed, at least in part, by one or more hardware logic components (e.g., the processor(s) 505). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” or “engine” can refer to hardware processing units or to software objects, routines, or methods that may be executed on computer system 500. The different components, modules, engines, and services described herein may be implemented as objects or processors that execute on computer system 500 (e.g. as separate threads).

Storage 510 may be physical system memory, which may be volatile, non-volatile, or some combination of the two. The term “memory” may also be used herein to refer to non-volatile mass storage such as physical storage media. If computer system 500 is distributed, the processing, memory, and/or storage capability may be distributed as well.

Storage 510 is shown as including executable instructions 515. The executable instructions 515 represent instructions that are executable by the processor(s) 505 of computer system 500 to perform the disclosed operations, such as those described in the various methods.

The disclosed embodiments may comprise or utilize a special-purpose or general-purpose computer including computer hardware, such as, for example, one or more processors (such as processor(s) 505) and system memory (such as storage 510), as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 500 may also be connected (via a wired or wireless connection) to external sensors (e.g., one or more remote cameras) or devices via a network 520. For example, computer system 500 can communicate with any number devices or cloud services to obtain or process data. In some cases, network 520 may itself be a cloud network. Furthermore, computer system 500 may also be connected through one or more wired or wireless networks to remote/separate computer systems(s) that are configured to perform any of the processing described with regard to computer system 500.

A “network,” like network 520, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 500 will include one or more communication channels that are used to communicate with the network 520. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for migrating a virtual machine (VM) from being hosted by a first processing element to being hosted by a second processing element, said method comprising:
determining that the VM is to be migrated from being hosted by the first processing element to being hosted by the second processing element, wherein the first processing element and the second processing element have access to a common pool of data storage resources, and wherein VM data for the VM is stored at a first storage location in the common pool of data storage resources;
triggering a migration of the VM from initially being hosted by the first processing element to subsequently being hosted by the second processing element;
as a part of the migration of the VM, preventing the VM data from being transferred from the first storage location to a second storage location such that the VM data is caused to remain at the first storage location despite the migration of the VM to the second processing element;
as a part of the migration of the VM, generating or accessing a memory pointer that points to the first storage location in the common pool of data storage resources;
causing the second processing element to host a new VM, the new VM being a migrated version of the VM; and
configuring the new VM to access the first storage location via the memory pointer, wherein the new VM uses the memory pointer to access the VM data, which continuously remained stored at the first storage location during the migration of the VM.

2. The method of claim 1, wherein the first processing element is a first system on a chip (SOC), and wherein the second processing element is a second SOC.

3. The method of claim 2, wherein the first SOC is a first node in a multi-socket platform, and wherein the second SOC is a second node in the multi-socket platform.

4. The method of claim 1, wherein the common pool of data storage resources includes a plurality of solid state drives (SSDs).

5. The method of claim 4, wherein an interposer is logically disposed between (i) the first processing element and the second processing element and (ii) the plurality of SSDs.

6. The method of claim 5, wherein the interposer causes the plurality of SSDs to appear to be contiguous to the first processing element and the second processing element.

7. The method of claim 1, wherein an encryption of the VM data remains unchanged during the migration of the VM.

8. The method of claim 1, wherein the first processing element is a first node is a multi-socket platform and the second processing element is a second node in the multi-socket platform, and wherein the multi-socket platform is a partitioned platform.

9. The method of claim 1, wherein the first processing element and the second processing element operate under control of a single hypervisor.

10. The method of claim 1, wherein the first processing element and the second processing element operate under control of a single operating system.

11. The method of claim 1, wherein the first processing element operates using a first operating system (OS), and wherein the second processing element operates using a second OS.

12. The method of claim 1, wherein the first processing element is a first node in a multi-socket platform and the second processing element is a second node in the multi-socket platform, and wherein the multi-socket platform is a coherent platform.

13. The method of claim 1, wherein the memory pointer is a directory pointer.

14. The method of claim 1, wherein the memory pointer is a file system pointer.

15. The method of claim 1, wherein the memory pointer is an existing memory pointer that the VM used to access the common pool of data storage resources while the VM was being hosted by the first processing element.

16. A computer system that migrates a virtual machine (VM) from being hosted by a first processing element to being hosted by a second processing element, said computer system comprising:
at least one processor; and
at least one hardware storage device that stores instructions that are executable by the at least one processor to cause the computer system to:
determine that the VM is to be migrated from being hosted by the first processing element to being hosted by the second processing element, wherein the first processing element and the second processing element have access to a common pool of data storage resources, and wherein VM data for the VM is stored at a first storage location in the common pool of data storage resources;
trigger a migration of the VM from initially being hosted by the first processing element to subsequently being hosted by the second processing element;
as a part of the migration of the VM, prevent the VM data from being transferred from the first storage location to a second storage location such that the VM data is caused to remain at the first storage location despite the migration of the VM to the second processing element;
as a part of the migration of the VM, generate or access a memory pointer that points to the first storage location in the common pool of data storage resources;
cause the second processing element to host a new VM, the new VM being a migrated version of the VM; and
configure the new VM to access the first storage location via the memory pointer, wherein the new VM uses the memory pointer to access the VM data, which continuously remained stored at the first storage location during the migration of the VM.

17. The computer system of claim 16, wherein preventing the VM data from being transferred from the first storage location to the second storage location involves refraining from performing a data cut and paste operation or a data copy and paste operation.

18. The computer system of claim 16, wherein the VM data remains unchanged during the migration of the VM.

19. The computer system of claim 16, wherein the VM, upon initialization at the first processing element, is allocated virtual memory, which includes virtual memory corresponding to the first storage location, and
wherein the new VM is allocated the same virtual memory that was allocated to the VM.

20. A method for migrating a virtual machine (VM) from being hosted by a first processing element to being hosted by a second processing element, said method comprising:
determining that the VM is to be migrated from being hosted by the first processing element to being hosted by the second processing element, wherein:
the first processing element and the second processing element have access to a common pool of data storage resources,
VM data for the VM is stored at a first storage location in the common pool of data storage resources, and
an interposer is logically disposed between (i) the first processing element and the second processing element and (ii) the common pool of data storage resources;
triggering a migration of the VM from initially being hosted by the first processing element to subsequently being hosted by the second processing element;
as a part of the migration of the VM, preventing the VM data from being transferred from the first storage location to a second storage location such that the VM data is caused to remain at the first storage location despite the migration of the VM to the second processing element;
as a part of the migration of the VM, generating or accessing a memory pointer that points to the first storage location in the common pool of data storage resources;
causing the second processing element to host a new VM, the new VM being a migrated version of the VM;
configuring the new VM to access the first storage location via the memory pointer, wherein the new VM uses the memory pointer to access the VM data, which continuously remained stored at the first storage location during the migration of the VM.
